(19) United States
(12) Patent Application Publication
(10) Pub. No.: US 2007/0084096 A1
(43) Pub. Date: Apr. 19, 2007

(54) Combined wall calendar and picture frame collage kit

(76) Inventors: William Penrod Davis, Sandy, UT (US); Barbara Joan Davis, Sandy, UT (US)

Correspondence Address: WILLIAM PENROD DAVIS, 835 CHARLESTON CIRCLE, SANDY, UT, 84094, US

(21) Appl. No.: 11/529,149

(22) Filed: Sep. 28, 2006

Related U.S. Application Data
(60) Provisional application No. 60/723,206, filed on Oct. 3, 2005.

(51) Int. Cl. G09F 7/00

(52) U.S. Cl. 40/492

(57) ABSTRACT

A combined wall calendar and picture frame collage kit which, when assembled, allows a user to insert his or her pictures or photos of choice into the graphic material holding units attached to the photo display page. The photo display page may be customized and/or designed for an individual or by the individual. The calendar page is substantially circular in shape. The photo display page is circular in shape with a ninety degree cut out running from the center of the page to the outer edge of the circle. The assembly and construction of the kit components are such that when the calendar page and the photo display page are attached, by means of a nylon binding post with screw, the calendar may be alligned so that three calendar months are displayed. When the calendar page is turned ninety degrees counterclockwise, the calendar will display the next three months of the calendar year.

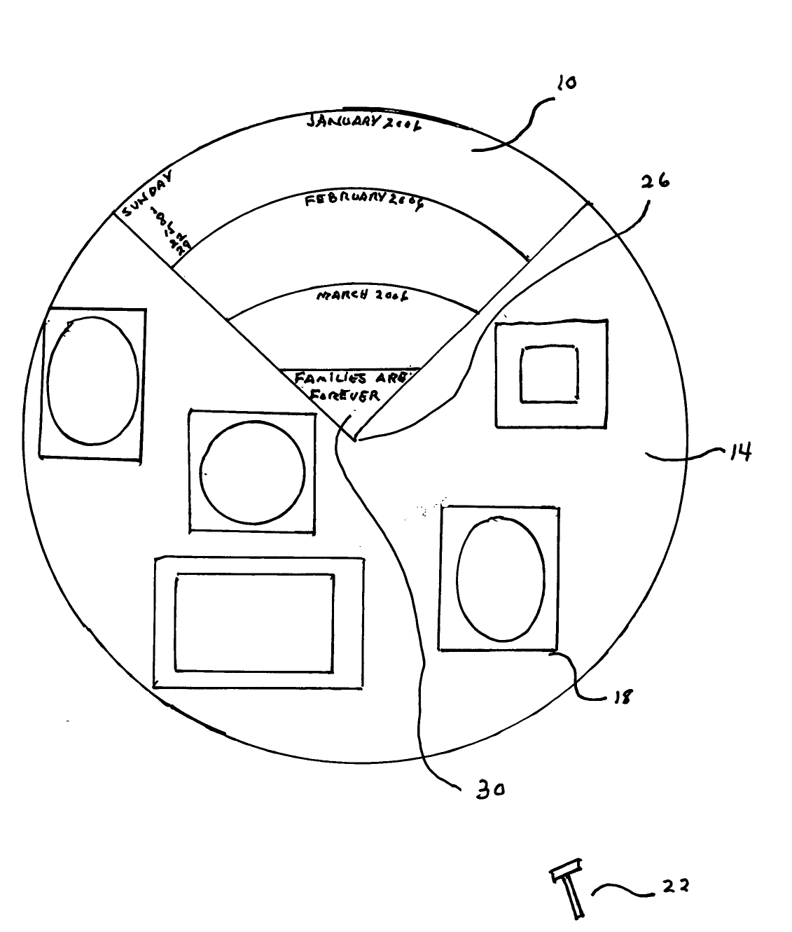

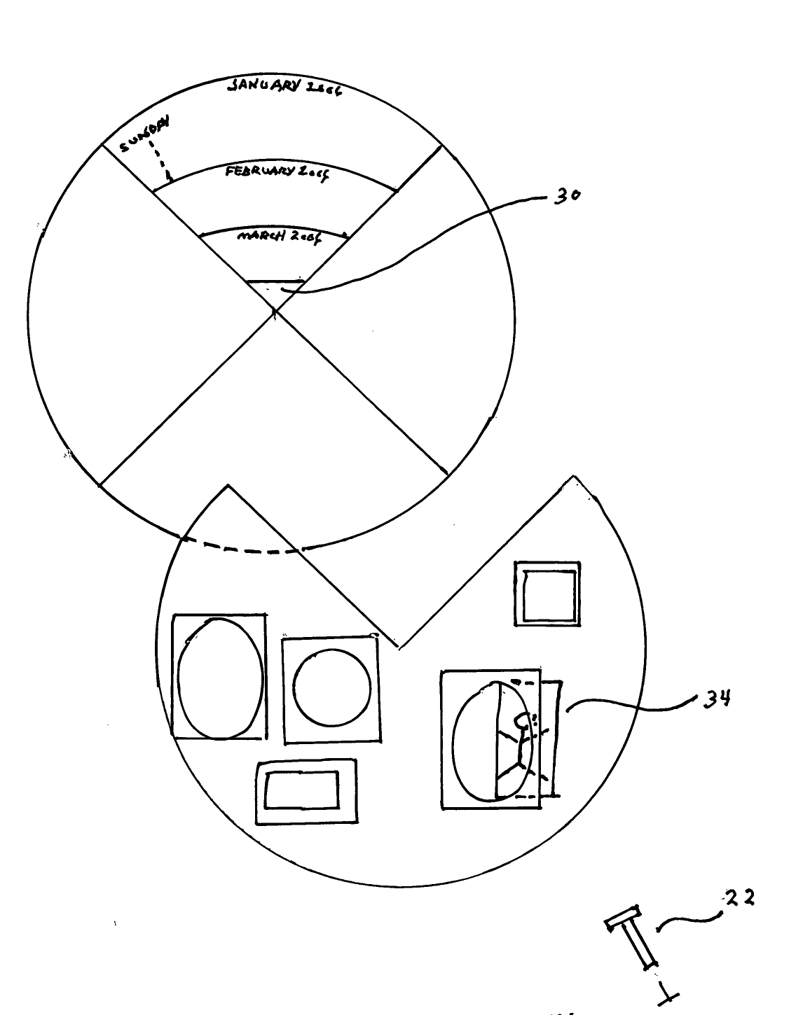

This application claims the benefit of U.S. provisional application Ser. No. 60/723,206 filed Oct. 3, 2005.

References Cited

| | | | |
|---|---|---|---|
| 137269 | March, 1921 | Stevens | 40/119 |
| 2526575 | October, 1950 | Neal | 40/119 |
| 5426876 | June, 1995 | Jagoe | 40/119 |
| 5661918 | September, 1997 | Malcolm | 40/107 |

### FEDERALLY SPONSORED RESEARCH

Not applicable

### SEQUENCE LISTING OR PROGRAM

Not applicable

### BACKGROUND OF THE INVENTION

1. Field of Invention

This invention relates in general to a scrapbook calendar kit, and more specifically to round wall calendars provided with the means for organizing and changing the artistic display of photographs, pictures and other graphic works.

2. Prior Art

Pictures are often displayed with calendars to make the calendars more attractive. Usually calendars display a new picture with each month. Sometimes a single picture may be used the entire year.

In some cases calendars have been designed so that a person can put their own pictures or photographs in the space above the calendar page as in U.S. Pat. No. 5,426,876 issued on Jun. 27, 1995 to B. and J. Jagoe.

The problem with most calendars that incorporate pictures or photographs is that it is time consuming or impossible to change the pictures. The above problem will be solved with the application of the present invention which will be described below.

### SUMMARY OF THE INVENTION

The present invention overcomes this and other problems by providing a calendar which discloses a circular photo display page to which a plurality of picture frame units of diparate size and shape are the photo or graphic material holding means. It is lightweight, easily hung and displayed. The pictures or photos may be easily changed to fit the season or the taste of the individual. The combination wall calendar and picture frame collage kit provides almost unlimited picture combinations and embellishments.

The combined wall callendar and picture frame collage kit may be customized and/or predesigned for an individual or by the individual.

### BRIEF DESCRIPTION OF DRAWINGS

Illustration 1/2 is an assembled view of the combined wall calendar picture frame collage kit, hanging on the wall.

Illustration 2/2 is an exploded view of the combined wall calendar picture frame collage kit, with a photograph 34 partially inserted into a frame or more specifically one of the graphic material holding means.

### DETAILED DESCRIPTION OF THE PREFERRED EMBODIMENTS

For clarity and ease of understanding, the same reference numerals are used to refer to similar structures throughout the drawing figures.

Illustration 1/2 show an embodiment #1 of the assembled combination wall calendar and picture frame collage kit, made according to the present invention is disclosed.

The combination wall calendar and picture frame collage kit, as shown in illustration 1/2 includes generally, a calendar page 10, a photo display page 14, graphic material holding means 18, consisting of five picture frame units of disparate size and shape, and a means of attachment 22, of the pages, namely a binding post with screw, composed of nylon or other suitable material.

Said means of attachment 22, is inserted in hole 26.

Calendar page 10 and photo display page 14 are substantially circular in shape and constructed of any suitable material such as, paper, paperboard, coated paper etc. Graphic material holding means 18 are, in the in the embodiment shown attached to the photo display page 14 by means of double sided adhesive tape, tacky adhesive or other suitable material.

The graphic material holding means 18 are partially attached to allow sufficient space for the insertion and removal of photographs and other graphic material.

Illustration 2/2 shows an embodiment #2 of the combination calendar and picture frame collage kit, made according to the present invention is disclosed.

The combination wall calendar and picture frame collage kit as shown in illustration 2/2 displays a small space 30 for a short quotation to be included.

Embodiment #3 includes an annual refillable calendar page.

Having thus described in detail the three preferred embodiments of the present invention, it is to be appreciated and will be apparent to those skilled in the art that many physical changes could be made in the invention without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

Illustration Reference Numerals

10 calendar page
14 photo display page
18 graphic material holding means
22 a means-of attachment of pages
26 hole
30 quotation space
34 photograph partially inserted

We claim:

1. A combined wall calendar and picture frame collage kit for displaying calendar information and graphic material in an optionally determined arrangement. The graphic material can be changed without disturbing the calendar information. Said combined wall calendar and picture frame collage kit is comprised of a calendar page, a photo display page, graphic material holding means, and a means of attachment of pages. Said calendar page being substantially circular in shape, with a predetermined hole in the center. Said photo display page being substantially circular in shape with a predetermined hole in the center and a ninety degree cut out running from said center hole to the outside of the circle. Said predetermined hole in the center enables the calendar page and the photo display page to be attached by means of a binding post with screw, composed of nylon or other suitable material. Said graphic material holding means consists of five picture frame units of disparate size and shape, to be attached to the photo display page in an optionally determined design, by means of two sided tape, glue or other suitable adhesive material.

2. A combined wall calendar and picture frame collage kit of claim 1. Said calendar page displays the twelve calendar months of the year, in order, three at a time beginning with january, february and march. Said photo page being positionable to cover the other nine months of april through december. When said assembled calendar page is rotated counter clockwise ninety degrees it displays the next three months of the calendar year, in order.

3. A combined wall calendar and picture frame collage kit of claim 1, said graphic material holding means consisting of five picture frame units. Each picture frame unit has two congruent sides with a perpendicular perforation in the center, for folding over and holding graphic material. One side is cutout and shaped to form and frame the five picture frame units of disparate size and shape.

4. A kit comprising a calendar page, a photo display page, graphic material holding means, and a means of attachment of pages. Said combined wall calendar and picture frame collage kit of claim 1, the photo display page may be customized and/or predesigned for an individual or by the individual.
